(19) United States
(12) Patent Application Publication
(10) Pub. No.: US 2019/0384308 A1
(43) Pub. Date: Dec. 19, 2019

(54) CAMERA BASED DOCKING OF VEHICLES USING ARTIFICIAL INTELLIGENCE

(71) Applicant: ZF FRIEDRICHSHAFEN AG, Friedrichshafen (DE)

(72) Inventors: Christian Herzog, Friedrichshafen (DE); Martin Rapus, Friedrichshafen (DE)

(73) Assignee: ZF FRIEDRICHSHAFEN AG, Friedrichshafen (DE)

(21) Appl. No.: 16/433,257

(22) Filed: Jun. 6, 2019

(30) Foreign Application Priority Data
Jun. 13, 2018 (DE) 10 2018 209 382.2

(51) Int. Cl. G05D 1/02; G06N 3/08

(52) U.S. Cl. CPC G05D 1/0225; G05D 1/0246; G05D 2201/0213; G06N 3/08; G05D 1/0221

(57) ABSTRACT

An evaluation device (20) on a docking station (10), comprising an input interface (21) for receiving at least one image (34) of the docking station (10) recorded with an imaging sensor (31) that can be placed on a vehicle (30), wherein the evaluation device is configured to run an artificial neural network (4) that is trained to determined image coordinates of keypoints (11) of the docking station (10) based on the image, to determine a position and/or orientation of the imaging sensor (31) in relation to the keypoints (11) based on a known geometry of the keypoints (11), and to determine a position and/or orientation of the docking station (10) in relation to the vehicle (30) based on the determined position and/or orientation of the imaging sensor (31) and a known location of the imaging sensor (31) on the vehicle (30), and an output interface (22) for outputting a signal for a vehicle steering system (32) based on the determined position of the docking station (10) in relation to the vehicle (30) for controlling the vehicle (30) in order to dock it at the docking station (10). The invention also relates to a vehicle (30), a method, and a computer program for docking a vehicle (30) at a docking station (10), and an evaluation device (1) and a method for locating keypoints (11) of the docking station (10).

### FIELD

The invention relates to an evaluation device for locating keypoints of a docking station according to claim 1. The invention also relates to a method for locating keypoints of a docking station according to claim 2. The invention furthermore relates to an evaluation device for automated docking of a vehicle at a docking station according to claim 4. Moreover, the invention relates to a vehicle for automated docking at a docking station according to claim 6. The invention also relates to a method for automated docking of a vehicle at a docking station according to claim 7. Lastly, the invention relates to a computer program for docking a vehicle at a docking station according to claim 13.

### DESCRIPTION OF RELATED ART

One challenge for automated driving is maneuvering in street traffic. Another comprises automated driving in docking procedures, in particular in the field of commercial vehicles, in which goods are loaded and/or tools are exchanged, for example.

GB 2 513 393 describes an arrangement comprising a camera and a target. The camera is attached to a vehicle. The target, e.g. a pattern board, is attached to a trailer. When the target is identified and located in the images recorded by the camera, a trajectory can be calculated. This trajectory describes a path toward the trailer that the vehicle must travel in order to hook up the trailer.

DE 10 2006 035 929 B4 discloses a method for a sensor-supported guidance beneath an object, or driving into an object, in particular a swap body, with a commercial vehicle, wherein environmental information is recorded by at least one sensor located at the rear of the commercial vehicle, and wherein the relative positions of the object and the commercial vehicle are determined on the basis of the environmental information, wherein, depending on the distance, object features of a hierarchical model of the object are selected through the sensors in at least two phases, wherein as the commercial vehicle approaches the object, an individual model imaging of the object takes place based on individual object features through model adaptation. The hierarchical model varies with the distance to the swap body. By way of example, “rough” features are detected at greater distances, and the model is refined at closer distances, for a more precise localization.

### SUMMARY

This is the basis for the invention. The fundamental object of the invention is to improve automated docking of vehicles.

This object is achieved by an evaluation device for locating keypoints of a docking station that has the features of claim 1. The object is also achieved by a method for locating keypoints of a docking station that has the features of claim 2. Furthermore, the object is achieved by an evaluation device for automated docking of a vehicle at a docking station that has the features of claim 4. Moreover, the object is achieved by a vehicle for automated docking in a docking station that has the features of claim 6. The object is also achieved by a method for automated docking of a vehicle in a docking station that has the features of claim 7. Lastly, the object is achieved by a computer program for docking a vehicle in a docking station that has the features of claim 13.

Advantageous embodiments and further developments are given in the dependent claims.

The evaluation device according to the invention for locating keypoints of a docking station in images of the docking station comprises a first input interface for obtaining actual training data. The actual training data comprise the images of the docking station. Position data regarding the keypoints are provided as separate information for the training. The evaluation device also comprises a second input interface for obtaining target training data. The target training data comprise target position data for the respective keypoints in the images. The evaluation device is designed to forward propagate an artificial neural network with the actual training data, and to obtain target position data for the respective keypoints determined in this forward propagation with the artificial neural network. The evaluation device is also designed to adjust weighting factors for connections between neurons in the artificial neural network through backward propagation of a deviation between the actual position data and the target position data to minimize the deviation, in order to learn the target position data of the keypoints. The evaluation device also has an output interface for providing the actual position data.

The following definitions apply to the entire subject matter of the invention.

An evaluation device is a device that processes incoming information and outputs the results. In particular, an electronic circuit, e.g. a central processing unit or a graphics processor, is an evaluation device.

Keypoints, also referred to in English as keypoints, are the corner points of a trailer and/or further distinctive points on a trailer or a docking station. Thus, the keypoints, which are features of the docking station, are detected directly, according to the invention. This means empty spaces between supports for swap bodies are not drawn on for classification, such that there is no need for a complicated object/empty space model that varies with the distance to the swap body.

A docking station is an object that a vehicle can dock onto. In the docked state, the vehicle is coupled to the docking station. Examples of docking stations are a trailer, a container, a swap body, or a wharf, e.g. a landing bridge. A vehicle is a land vehicle, e.g. a passenger car, a commercial vehicle, e.g. a truck, or a towing vehicle such as a tractor, or a rail vehicle. A vehicle is also a water vehicle, e.g. a ship.

Images are pictures taken by the imaging sensors. A digital camera comprises an imaging sensor. The images are in color, in particular.

Artificial intelligence is a generic term for the automation of intelligent behavior. By way of example, an intelligent algorithm learns to react in a purposeful manner to new information. An artificial neural network, referred to in English as an artificial neural network, is an intelligent algorithm. An intelligent algorithm is designed to react in a purposeful manner to new information.

In order to be able to react in a purposeful manner to new information, it is necessary for an artificial intelligence to first learn the meaning of predetermined information. For this, the artificial intelligence is trained with validation data. Validation data is a general generic term for training data or test data. In particular, training data contain not only the actual data, but also information regarding the meaning of the respective data. This means that the training data forming the basis for the learning by the artificial intelligence, referred to as actual training data, is labeled. Target training data are the real, given information. In particular, the target position data comprise two dimensional image coordinates of the keypoints. This training phase is inspired by the learning process of a brain.

In particular, the validation data form a data set with which the algorithm is tested during the development period. Because decisions are also made by the developer, based on the tests, that have an effect on the algorithm, a further data set, the test data set, is drawn on at the end of the development phase, for a final evaluation. By way of example, images of the docking station in front of various backgrounds form a further data set.

The training with validation data is referred to as machine learning. A subgroup of the machine learning is deep learning, in which a series of hierarchical layers of neurons, so-called hidden layers, are used for carrying out the process of machine learning.

Neurons are the functional units of an artificial neural network. An output from a neuron is obtained in general as a value of an activation function, evaluated via a sum of the inputs weighted with weighting factors, plus a systematic error, the so-called bias. An artificial neural network with numerous hidden layers is a deep neural network.

The artificial neural network is a fully connected network, referred to in English as a fully connected network. In a fully connected network, each neuron in a layer is connected to all of the neurons in the preceding layer. Each connection has its own weighting factor. The artificial neural network is preferably a fully convolutional network. In a convolutional neural network, a filter is used with the same weighting factors on a layer of neurons, independently of the positions thereof. The convolutional neural network comprises numerous pooling layers between the convolutional layers. Pooling layers alter the dimensions of a two dimensional layer in terms of width and height. Pooling layers are also used for higher dimensional layers. The artificial neural network is preferably a convolutional neural network with an encoder/decoder architecture known to the person skilled in the art.

The evaluation device learns to identify keypoints in an image. The output of the artificial neural network is preferably a pixel-based probability for the keypoint, i.e. a so-called predicted heat map is obtained for each keypoint, which indicates the pixel-based probability of the keypoint. The target position data, also referred to as “ground truth heatmap,” then preferably comprise a two dimensional Gaussian distribution with a standardized height, the maximum of which is located at a keypoint. The deviation of the actual position data from the target position data is then minimized by means of a cross entropy between the ground truth heat map and the predicted heat map.

The method according to the invention for locating keypoints in a docking station in images of the docking station comprises the steps:

obtaining target training data and position data for the keypoints,

obtaining target training data, wherein the target training data comprise target position data for the respective keypoints in the images,

forward propagation of an artificial neural network with the actual training data and determination of actual position data for the respective keypoints with the artificial neural network,

backward propagation of a deviation between the actual position data and the target position data in order to adjust weighting factors for connections between neurons in the artificial neural network such that the deviation is minimized, in order to learn the target position data for the keypoints.

The method is a training method for the artificial neural network. In the so-called training phase, connections between neurons are evaluated with weighting factors. Forward propagation, referred to in English as “forward propagation,” means that information is fed to the input layer of the artificial neural network, passes through the subsequent layers, and is output in the output layer. Backward propagation, referred to in English as “backward propagation,” means that information passes through the layers backward, i.e. from the output layer toward the input layer. The deviations of the respective layers are obtained through successive backward propagation of a deviation obtained between target and actual data, from the output layer to the respective preceding layer until reaching the input layer. The deviations are a function of the weighting factors. The deviations between the actual output and the target output are evaluated by a cost function. In backward propagation, the degree of the error according to the individual weightings is backward propagated. In this manner, it is determined whether and to what degree the deviation between the actual and target outputs is minimized, when the respective weighting is increased or decreased. The weighting factors are altered by minimizing the deviation in the training phase, e.g. by means of the method of least squares, the cross entropy known from information theory, or the gradient descent method. As a result, when the input is input repeatedly, an approximation of the desired output is obtained. The backward propagation is explained comprehensively in Michael A. Nielsen, Neural Networks and Deep Learning, Determination Press, 2015, for example.

Advantageously, an evaluation device according to the invention for locating keypoints in a docking station is used for executing this process.

The training process is preferably carried out on a graphics processor that makes use of parallel computing.

The evaluation device according to the invention for automatic vehicle docking at a docking station comprises an input interface for obtaining at least one image of the docking station recorded with an imaging sensor that can be placed on the vehicle. The evaluation device is configured to run an artificial neural network. The artificial neural network is trained to determine image coordinates of the keypoints in the docking station based on the image. The evaluation device is also configured to determine a position and/or orientation of the imaging sensor in relation to the keypoints based on a known geometry of the keypoints. The evaluation device is also configured to determine a position and/or orientation of the docking station in relation to the vehicle based on the determined position and/or orientation of the imaging sensor and a known location of the imaging sensor on the vehicle. The evaluation device also comprises an output interface for providing a signal for a vehicle steering system based on the determined position of the docking station in relation to the vehicle, in order to automatically drive the vehicle to dock it at the docking station.

An imaging sensor provides images for each time stamp, and not merely a cluster of points, as is the case with radar, lidar or laser, for example.

Image coordinates are two dimensional coordinates for objects in a three dimensional space in the reference space of a two dimensional image of the object.

A vehicle steering system comprises control loops and/or actuators, with which a longitudinal and/or transverse guidance of the vehicle can be regulated and/or controlled.

As a result, the vehicle can advantageously be automatically driven to the right position in the docking station, and dock at the docking station. A signal comprises a steering angle, for example. As a result, an end-to-end process can also be implemented. The keypoint-based position estimation is advantageously very precise, and results in greater control, and thus greater certainty in the algorithm, compared to end-to-end learning.

The vehicle steering system preferably comprises a trajectory regulator.

A geometry of the keypoints is known, for example, from a three dimensional model of the docking station, e.g. the relative positions of the keypoints to one another. If no model is available, the keypoints are measured in advance, according to the invention. A position and/or orientation of the imaging sensors in relation to the keypoints is then obtained from the knowledge of the geometry of the keypoints, preferably based on intrinsic parameters of the imaging sensors. Intrinsic parameters of the imaging sensors determine how optical measurements of the imaging sensors and image points, in particular pixel values of the imaging sensors, relate to one another. By way of example, the focal length of a lens or the resolution of the imaging sensor is an intrinsic parameter of the imaging sensor.

The artificial neural network is preferably trained with the method according to the invention for locating keypoints in a docking station.

The vehicle according to the invention for automated docking in a docking station comprises a camera with an imaging sensor. The camera is located on the vehicle in order to obtain images of the docking station. The vehicle also comprises an evaluation device according to the invention, for automated docking of a vehicle in a docking station, which provides a signal to a vehicle steering system based on a determined position and/or orientation of the docking station in relation to the vehicle. The vehicle also comprises a vehicle steering system, for driving the vehicle automatically into the docking station based on the signal.

As a result, the vehicle can advantageously be driven automatically into the appropriate position in the docking station, and dock at the docking station. The vehicle is thus preferably an automated, preferably partially automated, vehicle. An automated vehicle is a vehicle that is technologically equipped such that it can control the respective vehicle with a vehicle steering system for tackling a driving task, including longitudinal and transverse guidance, after activating a corresponding automatic driving function, in particular a highly or fully automated driving function according to the standard SAEJ3016. A partially automated vehicle can assume specific driving tasks. A fully automated vehicle replaces the driver. The SAEJ3016 standard distinguishes between SAE Level 4 and SAE Level 5. Level 4 is defined in that the driving mode-specific execution of all aspects of the dynamic driving tasks are carried out by an automated driving system, even when the human driver does not react appropriately to requests by the system. Level 5 is defined in that all aspects of the dynamic driving tasks are executed by an automated driving system in all driving and environmental conditions that can be tackled by a human driver. A pure assistance system, to which the invention is likewise related, assists the driver in executing a driving task. This corresponds to SAE Level 1. The assistance system helps a driver in a steering maneuver by means of a visual output on a human machine interface, in English, a “human machine interface,” abbreviated as HMI. The human machine interface is a monitor, for example, in particular a touchscreen monitor.

The method according to the invention, for automated docking of a vehicle in a docking station comprises the steps:

obtaining at least one image of the docking station with an imaging sensor that can be placed on the vehicle,

running an artificial neural network that is trained to determine image coordinates of keypoints on the docking station based on the image,

determining a position and/or orientation of the imaging sensor in relation to the keypoints based on a known geometry of the keypoints,

determining a position and/or orientation of the docking station in relation to the vehicle based on the determined position of the imaging sensor and a known location of the imaging sensor on the vehicle, and

providing a signal for a vehicle steering system based on the determined position and/or orientation of the docking station in relation to the vehicle.

A prior manipulation of the docking station, e.g. by attaching a sensor, markings, or pattern board, is thus no longer necessary. A position and/or orientation of the docking station is identified by means of the recorded keypoints.

The vehicle steering system preferably automatically drives the vehicle to the docking station in order to dock, based on the signal. A vehicle can advantageously be docked in a docking station automatically by means of this method.

A known model of the docking station is advantageously used in determining the position and/or orientation of the imaging sensor in relation to the keypoints, based on a known geometry of the keypoints, wherein the model indicates the relative positions of the keypoints to one another.

Intrinsic parameters of the imaging sensor are advantageously used in the use of the known model.

A coordinate transformation from the imaging sensor system to the vehicle system is particularly preferably carried out in the determination of a position and/or orientation of the docking station in relation to the vehicle, based on the determined position of the imaging sensor and a known location of the imaging sensor on the vehicle. A trajectory to the docking station can be planned on the basis of the vehicle coordinate system.

Two dimensional projections of the keypoints are thus obtained by the artificial neural network from the knowledge of the relative three dimensional positions of the keypoints, and a trajectory to the docking station is determined by means of the method according to the invention.

Advantageously, an evaluation device according to the invention for automated docking of a vehicle at a docking station, or a vehicle according to the invention for automated docking of a vehicle at a docking station, is used for executing the method.

The computer program according to the invention for docking a vehicle at a docking station is designed to be loaded into a memory of a computer, and comprises software code segments with which the steps of the method according to the invention for automated docking of a vehicle at a docking station are carried out when the computer program runs on the computer.

A program belongs to the software of a data processing system, e.g. an evaluation device or a computer. Software is a collective term for programs and associated data. The complement to software is hardware. Hardware refers to the mechanical and electrical equipment in a data processing system. A computer is an evaluation device.

Computer programs normally comprise a series of commands by means of which the hardware is instructed to carry out a specific process when the program is loaded, which leads to a specific result. When the relevant program is used on a computer, the computer program results in a technological effect, specifically the obtaining of a trajectory plan for automatically docking at a docking station.

The computer program according to the invention is independent of the platform on which it is run. This means that it can be executed on any arbitrary computer platform. The computer program is preferably executed on an evaluation device according to the invention for automated docking of a vehicle at a docking station.

The software code segments are written in an arbitrary programming language, e.g. Python.

### BRIEF DESCRIPTION OF THE DRAWINGS

The invention is explained by way of example in reference to the figures. Therein:

FIG. 1 shows an exemplary embodiment of a vehicle according to the invention and an exemplary embodiment of a docking station;

FIG. 2 shows an exemplary embodiment of a docking station;

FIG. 3 shows an exemplary embodiment of an evaluation device according to the invention for locating keypoints of a docking station;

FIG. 4 shows a schematic illustration of the method according to the invention for locating keypoints of a docking station;

FIG. 5 shows an exemplary embodiment of an evaluation device according to the invention for automated docking of a vehicle at a docking station, and

FIG. 6 shows an exemplary embodiment of a method according to the invention for automated docking of a vehicle at a docking station.

### DETAILED DESCRIPTION

The same reference symbols in the figures refer to identical or functionally similar components. The respective relevant components are labeled in the individual figures.

FIG. 1 shows a tractor as the vehicle 30. The tractor pulls a trailer, which serves as the docking station for the tractor. The vehicle is coupled to the docking station 10 when it arrives. The driving to the docking station 10 and the docking take place automatically. The vehicle has a camera 33 for this.

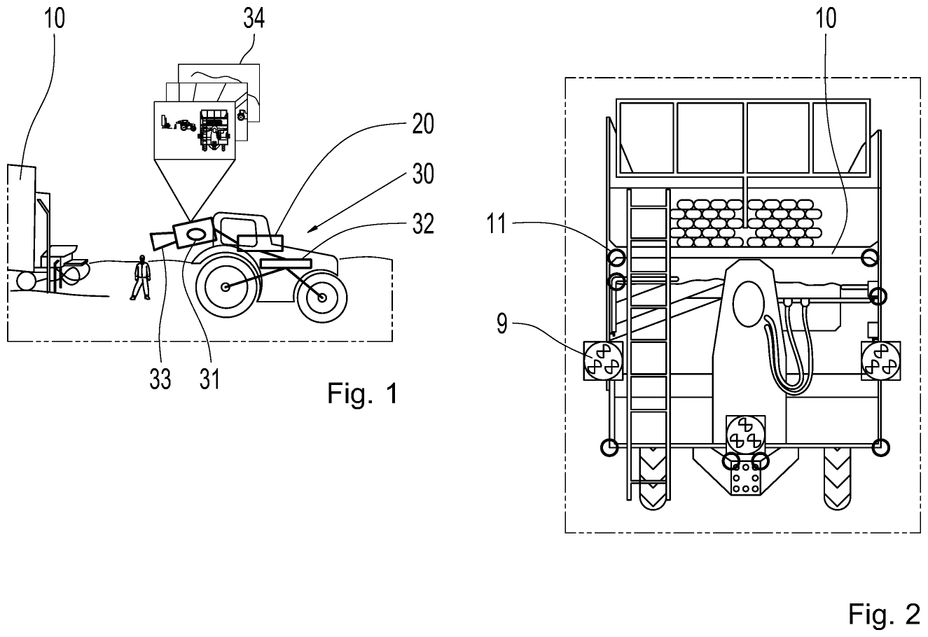

The camera 33 takes images 34 that include a rear view from the vehicle 30. The docking station 10 is recorded in the images 34. In particular, the keypoints 11 shown in FIG. 2 are recorded. FIG. 2 also shows a pattern board 9, by means of which a position and/or orientation of the docking station 10 can also be detected. According to the invention, pattern boards 9 are not, however, absolutely necessary. The camera 33 comprises an imaging sensor 31. The imaging sensor 31 transmits images 34 to an evaluation device 20 for the automated docking of the vehicle 30 at the docking station 10.

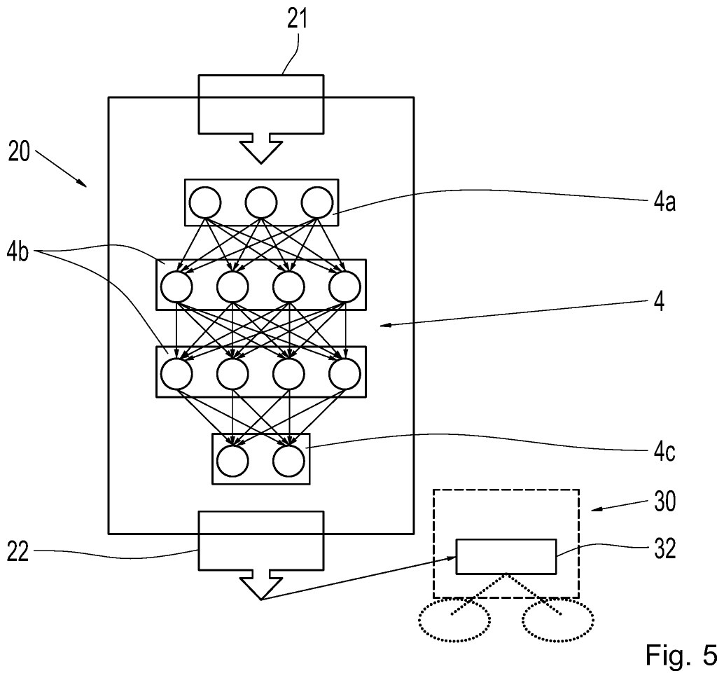

The evaluation device 20 is shown in FIG. 5. The evaluation device 20 receives the images 34 from the imaging sensor via an input interface 21. The images 34 are provided to an artificial neural network 4.

The artificial neural network 4 is a fully convolutional network. The artificial neural network 4 comprises an input layer 4a, two hierarchical layers 4b and an output layer 4c. The artificial neural network can also comprise numerous, e.g. more than 1,000, hierarchical layers 4b.

The artificial neural network 4 is trained according to the method shown in FIG. 4 for locating keypoints 11 of a docking station 10 in images 34. This means that the artificial neural network 4 calculates the image coordinates of the keypoints based on the image 34, and derives therefrom a position and orientation of the docking station 10 in relation to the vehicle based on the geometry of the keypoints and the location of the imaging sensor 31 on the vehicle 30. Based on the position and orientation of the docking station 10 in relation to the vehicle 30, the evaluation device 20 calculates a trajectory for the vehicle 30 to the docking station 10, and outputs a corresponding control signal to the vehicle steering system 32. The control signal is provided by the evaluation device 20 to the vehicle steering system 32 via an output interface 22.

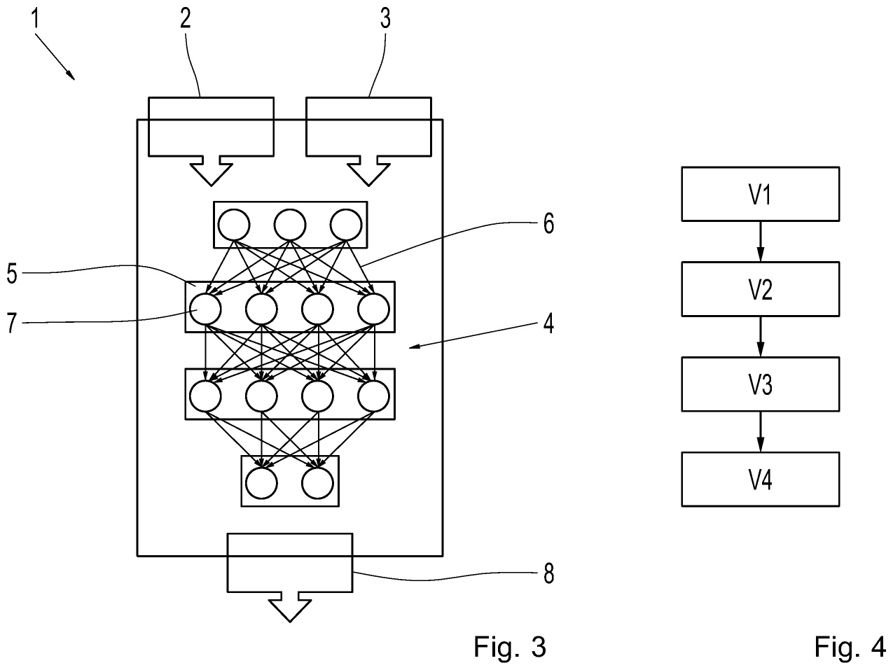

The training process for locating the keypoints 11 of the docking station 10 in images 34 of the docking station 10 is carried out with the evaluation device 1 shown in FIG. 3 for locating keypoints 11 of a docking statin 10 in images 34 of the docking station 10. The images 34 are labeled in the training process, i.e. the keypoints 11 are marked in the images.

The evaluation device 1 comprises a first input interface 2. The evaluation device 1 receives actual training data via the first input interface 2. The actual training data are the images 34. The actual training data are received in the first step V1 shown in FIG. 4.

The evaluation device 1 also comprises a second input interface 3. The evaluation device 1 receives target training data via the second input interface 3. The target training data comprise target position data for the respective keypoints 11 in the labeled images 34. The target training data are received in the second step V2 shown in FIG. 4.

The evaluation device 1 also comprises an artificial neural network 4. The artificial neural network 4 exhibits an architecture similar to that of the artificial neural network 4 in the evaluation device 20 shown in FIG. 5, for example.

The artificial neural network 4 is forward propagated with the actual training data. The actual position data of the respective keypoints 11 are determined with the artificial neural network 4 in the forward propagation. The forward propagation, with the determination of the actual position data, takes place in step V3 shown in FIG. 4.

A deviation between the actual position data and the target position data is backward propagated through the artificial neural network 4. Weighting factors 5 for connections 6 between neurons 7 in the artificial neural network 4 are adjusted in the backward propagation such that the deviation is minimized. In doing so, the target positions of the keypoints 11 are learned. The learning of the target position data takes place in step V4 shown in FIG. 4.

The evaluation device 1 also comprises an output interface 8. The actual position data obtained with the artificial neural network 4, which approximate the target position data during the training process, are provided via the output interface.

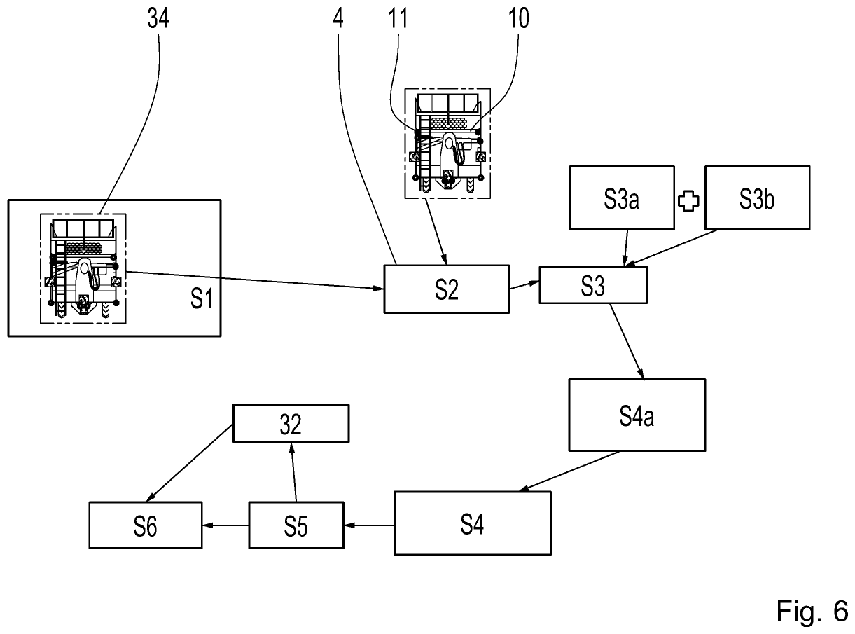

The method for automated docking of the vehicle 30 at the docking station 10 shown in FIG. 6 is carried out with the trained evaluation device 20 shown in FIG. 5. In a first step S1, at least one image 34 of the docking station 10 recorded with the imaging sensor 31 located on the vehicle 30 is obtained. The image 34 in this case is a typical image, without markings for keypoints 11.

In a further step S2, the artificial neural network 4 is run. The artificial neural network 4 is trained to determine image coordinates of the keypoints 11 of the docking station 10 based on the image 34.

In a third step S3, a position and/or orientation of the imaging sensor 31 in relation to the keypoints 11 is determined, based on a known geometry of the keypoints 11. The geometry of the keypoints 11 is determined in a step S3a by means of a known three dimensional model of the docking station 10, wherein the model indicates the relative positions of the keypoints 11 to one another. Intrinsic parameters of the imaging sensor 31 are used in the use of the known model in a step S3b.

In step S4, a position and/or orientation of the docking station 10 in relation to the vehicle 30 are determined based on the determined position of the imaging sensor 31 and a known location of the imaging sensor 31 on the vehicle 30. A coordinate transformation from the imaging sensor 31 system to the vehicle 30 system is carried out in step S4a. The position and/or orientation of the docking station 10 is known in the vehicle system through this coordinate transformation, in order to automatically dock the vehicle at the calculated position of the docking station 10 by means of the trajectory regulation.

In step S5, a signal for the vehicle steering system 32 is provided, based on the determined position and/or orientation of the docking station 10 in relation to the vehicle 30.

In step S6, the vehicle steering system 32 automatically drives the vehicle 30 to the docking station for docking, based on the signal.

### REFERENCE SYMBOLS

1 evaluation device
2 first input interface
3 second input interface
4 artificial neural network
4a input layer
4b hierarchical layer
4c output layer
5 weighting factors
6 connections
7 neurons
8 output interface
9 pattern board
10 docking station
11 keypoint
20 evaluation device
21 input interface
22 output interface
30 vehicle
31 imaging sensor
32 vehicle steering system
33 camera
34 image
V1-V4 steps
S1-S4 steps

1. An evaluation device for locating keypoints of a docking station in images of the docking station, comprising
a first input interface for receiving actual training data, wherein the actual training data comprise the images of the docking station, wherein the keypoints are marked in the images,
a second input interface for receiving target training data, wherein the target training data comprise target position data of the respective keypoints in the images,
wherein the evaluation device is configured to
forward propagate an artificial neural network with the actual training data and receive actual position data of the respective keypoints determined with the artificial neural network in this forward propagation, and
adjust weighting factors for connections between neurons in the artificial neural network through backward propagation of a deviation between the actual position data and the target position data, to minimize the deviation, in order to learn the target position data of the keypoints,
and
an output interface for outputting the actual position data.

2. A method for locating keypoints of a docking station in images of the docking station, comprising the steps
receiving actual training data and position data of the keypoints,
receiving target training data, wherein the target training data comprise target position data of the respective keypoints in the images,
forward propagation of an artificial neural network with the actual training data, and determining actual position data of the respective keypoints with the artificial neural network,
backward propagation of a deviation between the actual position data and the target position data in order to adjust weighting factors for connections between neurons of the artificial neural network such that the deviation is minimized, in order to learn the target position data of the keypoints.

3. The method according to claim 2, wherein an evaluation device according to claim 1 is used for executing the method.

4. An evaluation device for automated docking of a vehicle at a docking station, comprising
an input interface for receiving at least one image of the docking station recorded with an imaging sensor that can be placed on the vehicle,
wherein the evaluation device is configured to
run an artificial neural network that is trained to determine image coordinates of keypoints of the docking station based on the image,
determine a position and/or orientation of the imaging sensor in relation to the keypoints based on a known geometry of the keypoints, and
determine a position and/or orientation of the docking station in relation to the vehicle based on the determined position and/or orientation of the imaging sensor and a known location of the imaging sensor on the vehicle,
and
an output interface, for outputting a signal for a vehicle steering system based on the determined position of the docking station in relation to the vehicle, in order to automatically drive the vehicle to dock it at the docking station.

5. The evaluation device according to claim 4, wherein the artificial neural network is trained according to the method according to claim 2.

6. A vehicle for automated docking at a docking station, comprising
a camera with an imaging sensor, which is located on the vehicle, for obtaining images of the docking station,
an evaluation device according to claim 4, for outputting a signal for a vehicle control based on a determined position and/or orientation of the docking station in relation to the vehicle, and
a vehicle steering system, for driving the vehicle automatically in order to dock it at the docking station, based on the signal.

7. A method for automated docking of a vehicle at a docking station, comprising the steps:
obtaining at least one image of the docking station recorded with an imaging sensor that can be placed on the vehicle,
running an artificial neural network that is trained to determine image coordinates of keypoints of the docking station based on the image,
determining a position and/or orientation of the imaging sensor in relation to the keypoints based on a known geometry of the keypoints,
determining a position and/or orientation of the docking station in relation to the vehicle based on the determined position of the imaging sensor and a known location of the imaging sensor on the vehicle,
and
outputting a signal for a vehicle steering system based on the determined position and/or orientation of the docking station in relation to the vehicle.

8. The method according to claim 7, wherein the vehicle steering system automatically drives the vehicle in order to dock it at the docking station, based on the signal.

9. The method according to claim 7, wherein a known model of the docking station is used in determining the position and/or orientation of the imaging sensor in relation to the keypoints based on a known geometry of the keypoints, wherein the model indicates the relative positions of the keypoints to one another.

10. The method according to claim 9, wherein intrinsic parameters of the imaging sensor are used in the use of the known model.

11. The method according to claim 7, wherein coordinate transformation from the imaging sensor system to the vehicle system is carried out in determining a position and/or orientation of the docking station in relation to the vehicle based on the determined position of the imaging sensor and a known location of the imaging sensor on the vehicle.

12. The method according to claim 7, wherein an evaluation device according to claim 4 is used for executing the method.

13. A computer program for docking a vehicle at a docking station, wherein the computer program
is configured to be loaded into a memory of a computer, and
comprises software code segments with which the steps of the method according to claim 7 are executed when the computer program runs on the computer.

14. The evaluation device according to claim 4, wherein the artificial neural network is trained according to the method according to claim 3.

15. The method according to claim 8, wherein a known model of the docking station is used in determining the position and/or orientation of the imaging sensor in relation to the keypoints based on a known geometry of the keypoints, wherein the model indicates the relative positions of the keypoints to one another.

16. The method according to claim 8, wherein coordinate transformation from the imaging sensor system to the vehicle system is carried out in determining a position and/or orientation of the docking station in relation to the vehicle based on the determined position of the imaging sensor and a known location of the imaging sensor on the vehicle.

17. The method according to claim 9, wherein coordinate transformation from the imaging sensor system to the vehicle system is carried out in determining a position and/or orientation of the docking station in relation to the vehicle based on the determined position of the imaging sensor and a known location of the imaging sensor on the vehicle.

18. The method according to claim 10, wherein coordinate transformation from the imaging sensor system to the vehicle system is carried out in determining a position and/or orientation of the docking station in relation to the vehicle based on the determined position of the imaging sensor and a known location of the imaging sensor on the vehicle.

19. The method according to claim 7, wherein a vehicle according to claim 6 is used for executing the method.

20. The method according to claim 8, wherein an evaluation device according to claim 4.
